(19) United States
(12) Patent Application Publication
(10) Pub. No.: US 2009/0020978 A1
(43) Pub. Date: Jan. 22, 2009

(54) Gear Shifting System Particularly Adapted to Bicyles

(76) Inventor: Franck Savard, Planguenoual (FR)

Correspondence Address: YOUNG & THOMPSON, 209 Madison Street, Suite 500, ALEXANDRIA, VA, 22314, US

(21) Appl. No.: 11/663,196

(22) PCT Filed: Sep. 22, 2004
(86) PCT No.: PCT/FR04/02390

§ 371 Date: Sep. 10, 2008

(30) Foreign Application Priority Data
Sep. 25, 2003 (FR) 03/11266

(51) Int. Cl. B62M 25/04

(52) U.S. Cl. 280/238

(57) ABSTRACT

A gear shifting system (1) particularly characterized in that the values required for displacement of the gear-shifting elements(s) (e.g. front changer (Y1) and rear changer (Z1)), are applied to each program (s) (e.g.: indexed or non-indexed multibossed cam(s) which is/are integrated into at least one gear shifting elements (Y1) and/or (Z1). Preferably, the system is provided with more than one program (e.g. a cam for the front changer and a cam for the rear changer, both of which can be combined to form a single changer (preferably, a front changer), the programs being synchronized directly or indirectly, e.g. by a single control elements (X) (e.g. an indexed or non-indexed handle) acting via transmission elements (e.g. cables (4A) and (5A) cooperating with casings (6)). The system the performance of the changers by organizing, i.e. synchronizing, the gear ratios via a disk/drive pinion combination potential.

This invention relates to a gear shifting system especially adapted to bicycles.

For a bicycle, known gear shifting systems all work according to the same principle: it is the transmitter control means (most often attached to the handlebars) that provides the values required for movement of the gear shifting means (receiver control means: derailleur, for example). The major disadvantage of these systems, the transmission (linking) means (cable, for example) between the transmitter control means (play and parasitic tolerances already accumulated to it) and the gear shifting means, always more or less changes the efficiency between the desired movement of the gear shifting means and the movement obtained. This change is amplified by use over time, which is reflected by a drop in reliability, precision, comfort and even sometimes safety.

Parallel to classic separate controls, classic grip systems of derailleur synchronization do exist and especially one of my preceding inventions, filed at the INPI (European patent application) under No. 95450012.0 and called “Synchroshift” by the EGS Company, consisted of a single gear shifting control grip that synchronized traditional derailleurs.

Although delivering the desired synchronization result, this “Synchroshift” is again more delicate and more sensitive than the aforementioned traditional control means with respect to the quality of the cables and sheaths used; their maintenance is sometimes and even often tedious.

Another major disadvantage: the mediocre intrinsic efficiency (accumulation of play and production tolerances) that said grip, also with derailleurs, transmits. This lack of tolerance on the “passband” sometimes causes difficult or faulty changing of ratios.

Another disadvantage, and not the least, this “Synchroshift” dictates that the grip have a relatively significant size and thus volume, which adversely affects the at least visual desire to seem light.

According to a first characteristic, by integrating the values necessary for movement of the movement means for shifting gears to at least one of said gear shifting means, the system according to the invention is designed to eliminate these disadvantages and especially this poor control tolerance, or at least to considerably improve the efficiency between the controlled movement and the movement obtained, while offering more varied, to say nothing of universal, ergonomy and a “more sexy look” as well as a greater variety of synchronization combinations.

According to the invention the system comprises:
at least one traditional transmitter control means and/or at least one transmitter control means according to the invention, actuated by the user.
said transmitter control means will act via at least one traditional transmission means (connecting means) and/or according to the invention on at least one gear shifting means according to the invention (receiver control means: front derailleur and/or rear derailleur, for example) integrating directly among these components according to the invention at least one program (synchronized or unsynchronized between them if there are several) controlling (preferably as directly as possible) the movement of said gear shifting means (for example derailleur(s)) independently and thus possibly separating or (possibly if the bicycle is equipped with a second gear shifting system) controlling, preferably directly or indirectly synchronized (by an interposed transmission means according to the invention), the other gear shifting that could be a derailleur (back or front) according to the invention or traditional or of a different type (rear wheel hub with integrated gears, for example).

The name of the derailleur(s)—Hi-Fi (for High Fidelity)—would be perfectly well suited as a commercial name for the programmed front and/or rear derailleur(s) according to the invention. The synchronization system according to the invention that is based on at least one of the derailleurs according to the invention could be temporarily or definitively called “Synchroflash.”

According to particular embodiments:
Bicycle equipped with at least one derailleur according to the invention, characterized in that the gear shifting means uses a rear derailleur according to the invention and/or a front derailleur according to the invention comprising one and/or the other according to the invention a program (a cam (indexed or not) for example because it is simple, economical, reliable, small, light and without maintenance nor requires embarked or stored power in order to work) for positioning the chain on one of at least two driven cogs integral with the rear wheel (for example: 1 for the largest, 2; 3; 4; 5; 6; 7; 8; 9 for the smallest) and/or a program (a cam (indexed or not) for example) for positioning said chain on one of at least two drive chainrings integral with the crankset (for example: “A” for the smallest, “B” for the middle, and “C” for the largest); the chainring and/or the cog being selected and preferably synchronized (in the case in which two derailleurs are mounted on said bicycle) according to the desired gear (reduction ratio).
In the situation in which the bicycle is equipped with one gear shifting means on the crankset and one gear shifting means for the rear wheel and with, as a feature, that only one of the two gear shifting means is a derailleur according to the invention (preferably the front derailleur), this front derailleur according to the invention will synchronize the two gear shifting means by programs (implemented by, for example, cams integrally combined on a single derailleur; preferably the front in this case) implementing as above series of front/back gear combinations, such as, for example: A1; A2; A3; A4; B3; B4; B5; B6; B7; C5; C6; C7; C8; C9; optimizing through 3×9=27 combinations of possible ratios, a perfect progression of single gears genuinely used and recommended (avoiding exaggerated chain crossing), thus transforming “anarchic” derailleurs in a gear box that is organized corresponding to the succession (staging) of the desired reduction ratios.
At least one transmitter control means, assisted (exertion compensation spring acting more or less directly on the control means, for example) or unassisted, linked to at least one transmission means (at least one cable integral with a twistgrip on the handlebars, for example) or at least (according to the adopted ergonomy) two distinct transmitter control means (assisted or unassisted) (a grip and/or a handle and/or a lever and/or a trigger, for example, preferably at least one for the right hand to shift up and at least one for the left hand to shift down) will activate the program(s) (cam(s)) of one and/or the other of the derailleurs.
According to the desired result but also depending on the surrounding components (chain, cogs, chainrings . . . ), one and/or the other of the programs (cams) designated above will be able to be provided with “overshifting” zones (temporary overshooting and passage from the nominal side of the desired chain line, to enhance, accelerate and thus improve the changing of the cog and/or rim) on all or part of each gear shifting zone, before and/or after the chain line zone corresponding to the selected reduction ratio.
One and/or the other of the cams can be single action or double action. This type of double-action cam (in one and the same element or in several more or less distinct elements) is called desmodromic (with push and pull action), such as, for example, the cams supporting distribution of certain motorcycle engines (Ducati).
In the situation in which at least one of the two cams is double-action, the invention calls for eliminating all or part of the pertinent derailleur return means (return spring of the front derailleur fork and/or return spring of the roller of the rear derailleur and/or the possible return spring of the cam that is integral or not integral with the pulley on which at least one control cable is wound and hooked).
One and/or the other of the programs (cam(s) for example) could be reprogrammed according to the invention without any replacement of the part (component such as cam(s) for example) by acting at least only on the desired lateral displacement values for said derailleur(s): for example by using, according to the invention, a cam that actuates the rear derailleur that has bosses (raised) and thus a deformable profile (path) (for example: under the action of a small adjusting screw corresponding to each gear zone that can be selected).
According to the invention, the use of at least one of the derailleurs according to the invention (front and/or back) with a second gear shifting system (front and/or back derailleur according to the invention or not) allows the transmission means (cable, for example) to connect the control means (twistgrip for example) to the gear shifting systems (derailleur(s) according to the invention and possibly other).

The means of transmission (linkage) and possible synchronization between the transmitter control mean(s) (MCE) and the reduction ratio shifting means (front=MRF and rear=MRR) can be:

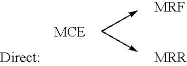

directly by at least one cable for each derailleur (for example grip/front derailleur and grip/rear derailleur),
in series: MCE→MRF→MRR→(possibly) MCE

in series by at least one cable (for example: grip/front derailleur/rear derailleur/grip (optionally) for example).

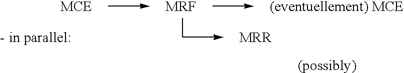

in parallel by at least one cable (for example: grip/front derailleur/grip); and at the same time between them (for example: by cable (toothed belt . . . ) front derailleur/rear derailleur/front derailleur (optionally) for example).
According to the invention, the transmitter control means activated by the user (pulley provided with a cable anchoring system, integral with the twistgrip for example) can be a manual clicked system or not and/or a vocal device and can have mechanical and/or hydraulic and/or pneumatic and/or electrical and/or Hertzian transmission means up to a receiver control means (pulley provided with a cable anchoring system that is integral with the cam, for example) compatible with the transmitter control means.
The transmitter control means (grip, for example) and/or the receiver control means (cam pulley(s), for example) according to the invention will be able to act permanently or interchangeably with continuous movement on all or some of the program(s) or in a sequential mode (due, for example, to two reversed and retractable pawls, working with a bidirectional drive system (a toothed wheel, for example) that is directly integral or not with said pulleys, by shifting at least one gear for each pulse with automatic (preferably) return to neutral.
According to the invention that one cam is integrated with each of the front and rear derailleurs or that the cams are integrated (monoblock or assembled) with one and the same derailleur, they are designed to cause the intended movement of the derailleur according to a program (multiboss cam profile, for example) predetermined according to the type of use of the bicycle (road or mountain biking, for example) and/or the prevailing topography (mountain or flat terrain, for example) or the type of user (man or woman or child, for example), definitively or optionally modifiable.

There is a major possibility, therefore, according to the invention, of modifying the staging of the gear shifting, by simply changing at least one of the front and/or rear derailing programs (cam(s)).
Generally, the program(s) (cams for example) of the derailleurs according to the invention can thus be controlled and actuated according to the invention by any (all) exclusive and/or hybrid device(s) or system(s).
The front and/or rear derailleur(s) according to the invention can have additional and/or related features according to the invention:
One or more elements of the invention can be more or less waterproof, more or less protected together or separately (total casing (and thus possible permanent lubrication) or partially of the transmission, chainring(s), chain, cog(s) and/or of the derailleur(s) for example).
The rear derailleur and/or front derailleur can have more than one chain tensioning wheel.
The front derailleur can have several adjustment possibilities (height, tilt and lateral offset in conjunction with the ad hoc crankset box) according to the frame and chainrings (especially “C”) installed by the builder or user.
The twistgrip can be of the click type or not, can display the selected gear or not, will have at least one cable groove and/or will allow the cable to be wound at least one entire or partial turn with joining by at least one cable head stop and/or at least one cable grip traversed by at least one transmission cable.
By simply changing (or modifying the reliefs) of the cam controlling the front derailleur, and/or by simply changing (or modifying the reliefs) of the cam controlling the rear derailleur, the system according to the invention makes it possible based on at least one single model of the derailleur (preferably the front one) to satisfy all possible cases of forms in terms of synchronized gear shifting or not.

Added as shown, to the possibilities of geometrical adjustment (in three directions) according to the invention, this front derailleur according to the invention can claim versatility of use.

The attached drawings illustrate the invention:

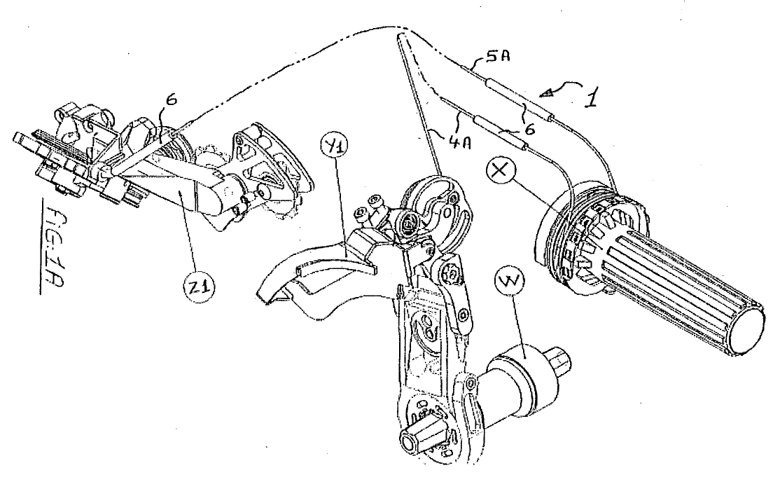

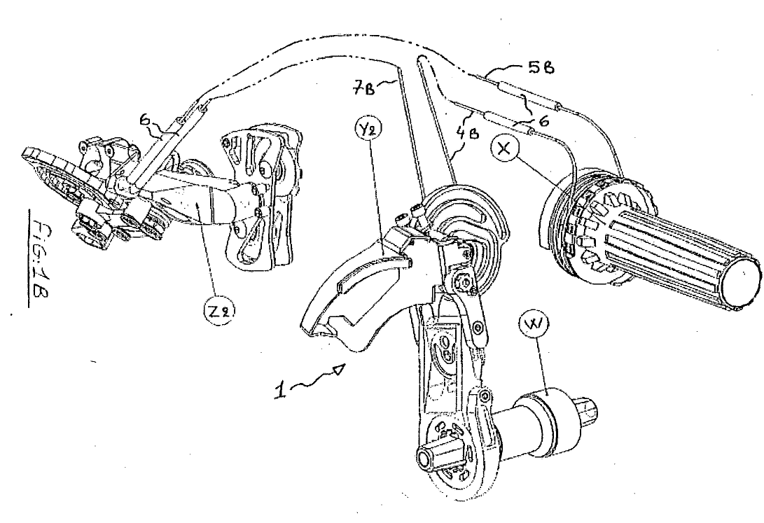

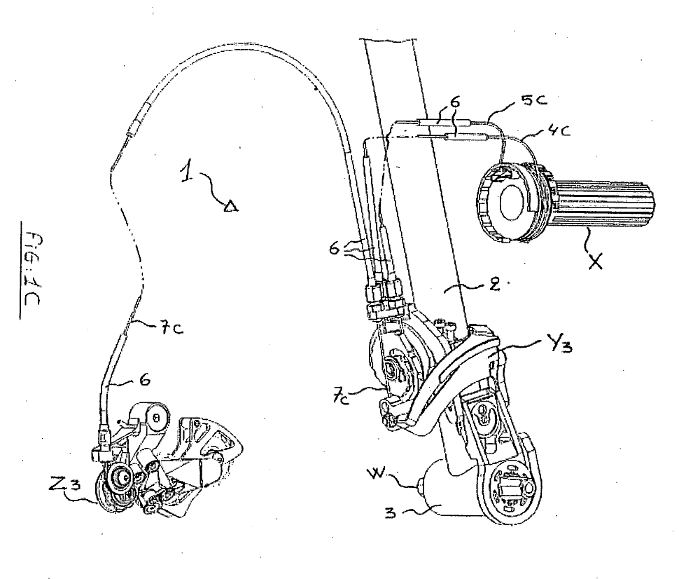

FIGS. 1 (1A, 1B, 1C) show the invention in its entirety:

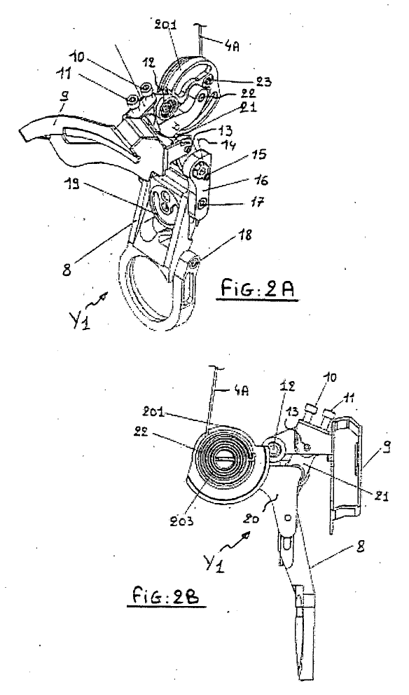

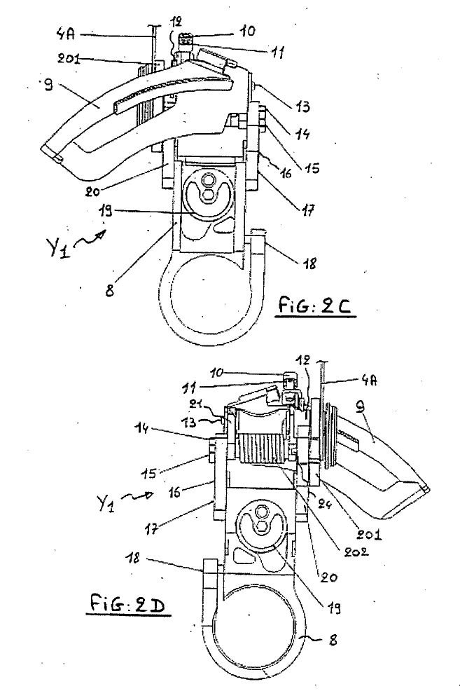

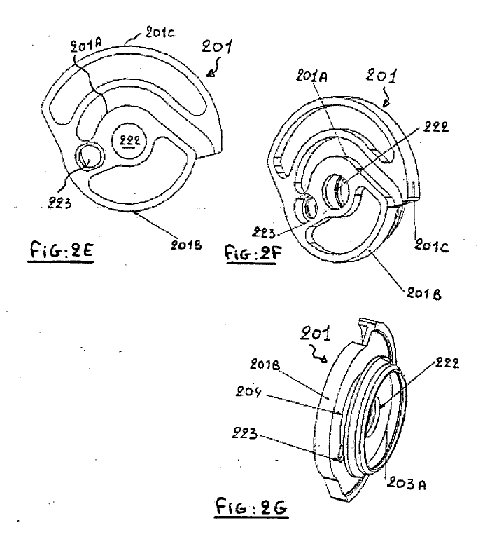

FIGS. 2 (2A, 2B, 2C, 2D) show a model of the front derailleur according to the invention and (2E, 2F, 2G) show one type of front cam according to the invention.

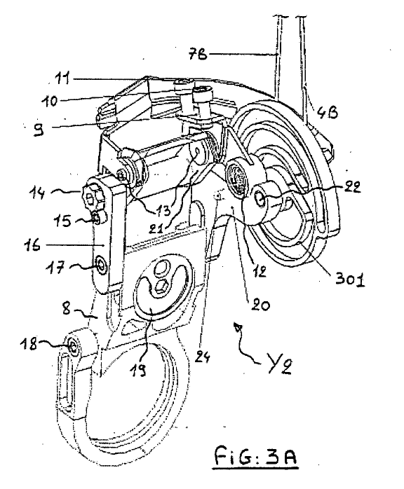

FIGS. 3 (3A) show one version of the front derailleur according to the invention; (3B, 3C, 3D) show a type of front cam according to the invention.

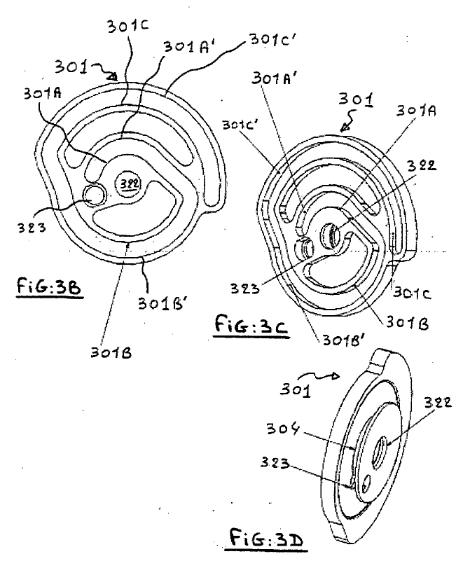

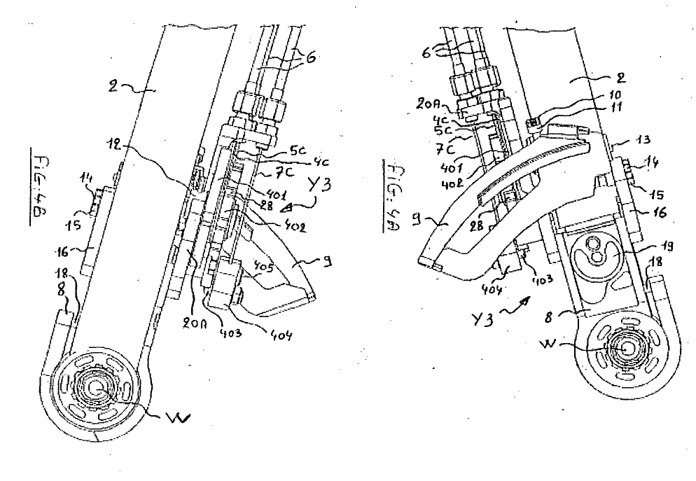

FIGS. 4 (4A, 4B, 4C, 4D, 4E, 4F) show one version of the front derailleur according to the invention; (4G, 4H) show a type of front/rear cam according to the invention.

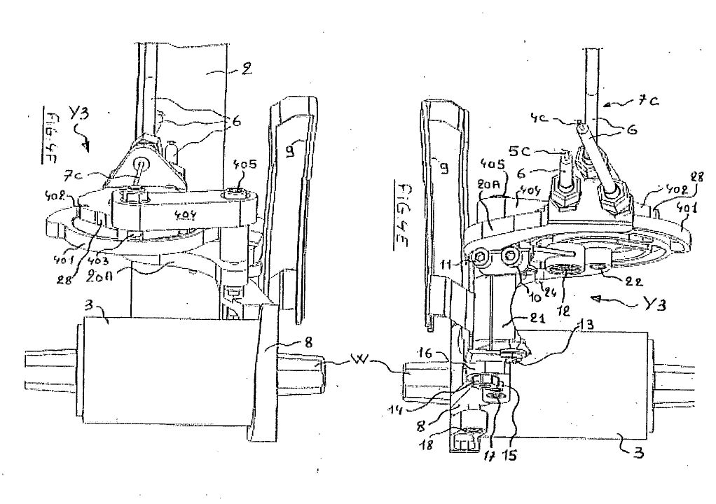

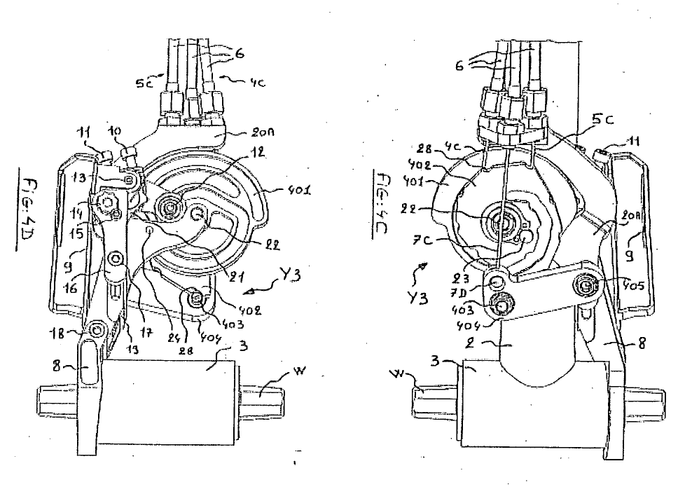

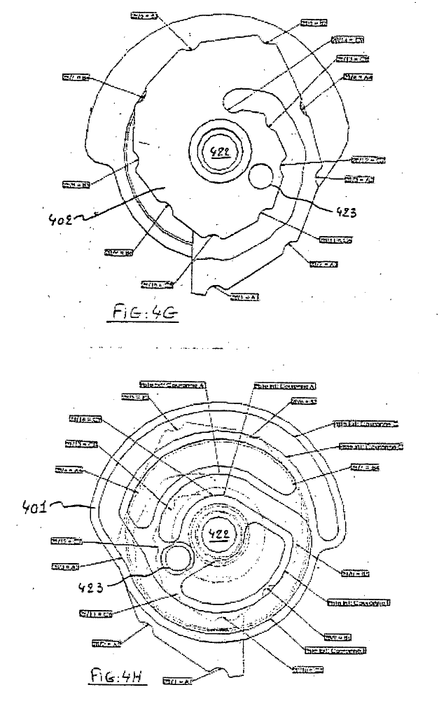

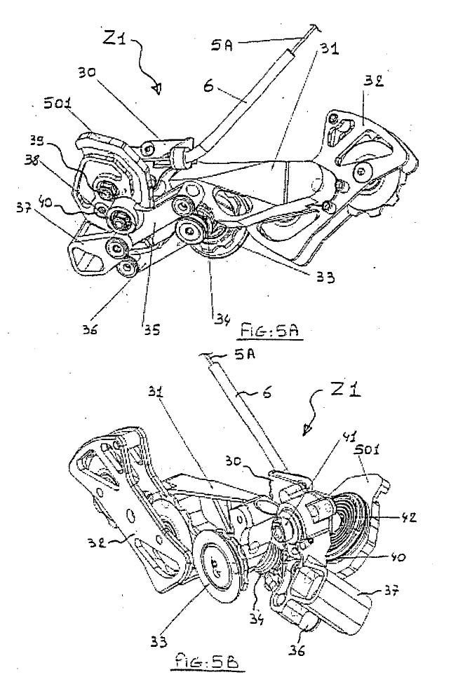

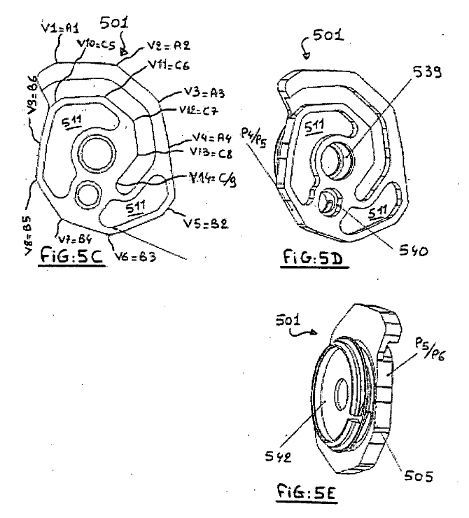

FIGS. 5 (5A, 5B) show a model of the rear derailleur according to the invention; (5C, 5D, 5E) show one type of rear cam according to the invention.

FIGS. 6 (6A, 6B) show a version of the rear derailleur according to the invention; (6C, 6D, 6E) show one type of rear cam according to the invention.

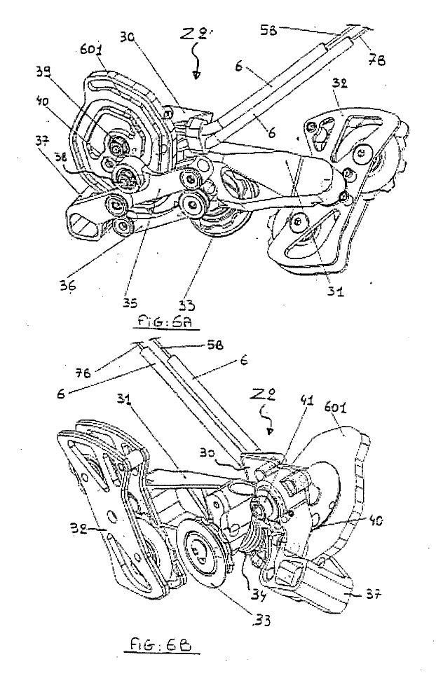

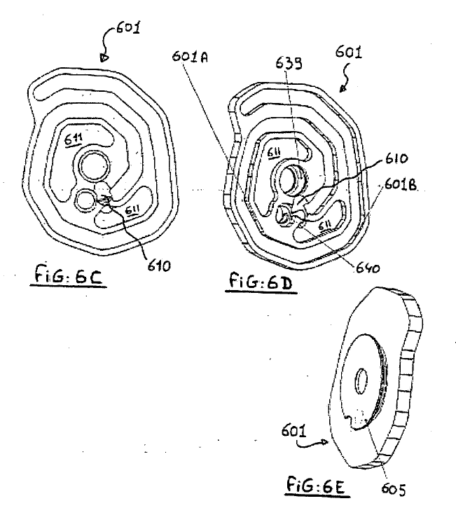

FIGS. 7 (7A, 7B, 7C) show a model of the twistgrip controlling at least one derailleur according to the invention.

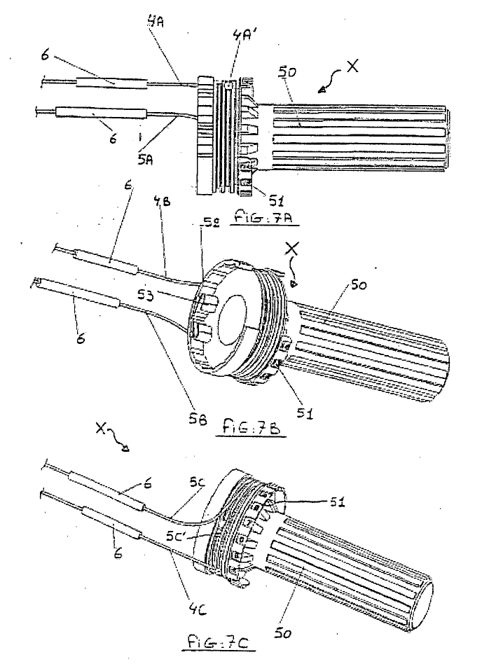

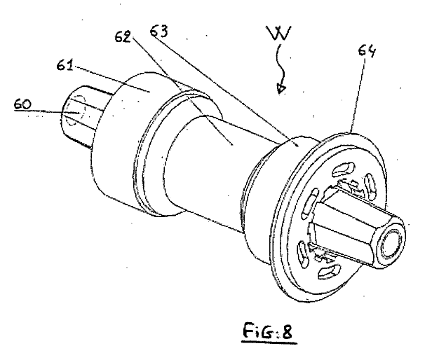

FIG. 8 shows a model of the crankset box according to the invention.

With reference to these drawings, generally everything with the same function has the same reference number. Preferably, certain parts very particular to the invention are referenced with a number in the hundreds that corresponds to the illustrative figure:

The overall system according to the invention is referenced (1).

The crankset box is referenced (W).

The transmitter control means (twistgrip) is referenced (X).

In the embodiment of the system (1) according to FIG. 1A, the grip (X) is integral with the first cable (4A) that, passing into at least one sheath (6), will transfer its positive pulling movement to a front derailleur according to the invention (Y1) and especially characterized by the fact that the cam (201) (the program) is single action. The same grip (X) is integral with a second cable (5A) that, passing into at least one other sheath (6), will transfer its positive pulling movement to a rear derailleur according to the invention (Z1) and especially characterized by the fact that the cam (501) (the program) is single action.

In this case, the most current and most interesting, (with respect to the lateral movement of the chain for derailing: It is easier for the derailleur return springs to cause the chain to “fall” into a cog or smaller rim than vice versa), the front derailleur (Y1) under the pulling force of the cable (4A) is moved from the small chainring “A” toward the largest chainring “C.” A return spring (202) drops the chain again toward the smaller chainrings.

Likewise, under the positive pulling force of the cable (5A), the rear derailleur (Z1) is moved from the smallest cog “1” to the largest cog “9.” A return spring (34) again moves the chain down toward the smaller cogs.

It follows that preferably for the operation of the grip (X), a cable (4A) (or one part) is wound when the other (5A) (or another part) unwinds and vice versa.

In spite of everything, and mainly to not have to compress exactly at least the return springs of the two derailleurs at the same time (since the very great majority, if not all of the available combinations through the ratios of chainring/cog combinations on the market necessitate (to have optimum staging of the gears for changing the chainrings) changing the cogs in the same direction, increasing or decreasing the size), the invention calls for the action of one of the cams to be the reverse in accordance with a return spring that is also inverse to it. The return force of a derailleur partially compensates at the level of exertion on the grip (X) for the return force of the other derailleur, thus improving the ease and comfort of use.

In the embodiment of the system (1) according to FIG. 1B, the grip (X) is integral with a first cable (4B) that, passing into at least one sheath (6), will transfer its pulling motion to a front derailleur according to the invention (Y2) and especially characterized by the fact that the cam (301) (the program) is double action. The same grip (X) is integral with a second cable (5B) that, passing into at least one other sheath (6), will transfer its pulling motion to a rear derailleur according to the invention (Z2) and especially characterized by the fact that the cam (601) (the program) is double action.

One cable (7B) closes the connection between the derailleurs (Y2) and (Z2) and the grip (X), since the cams (301) and (601) are double action; it is especially interesting no matter what the direction of lateral displacement adopted by the derailleurs (Y2) and (Z2) that said derailleurs work without any return spring (or with springs that are relatively very slightly calibrated and very soft to just ensure a slight tension in the cables (4B), (5B) and (7B)).

In this case, the control force of the user through the grip (X) and said cables (4B), (5B), (7B) allows all derailings to be implemented.

The control kinematics of this version is preferably the following: by turning the grip (X) in the direction of the first gear 1 toward the last gear 14, the cable (4B) is wound into the cable groove of the grip (X) where the head of said cable is housed. The pull applied to this cable is transferred through the sheath(s) (6) and various stops of the sheath(s) (not shown) as far as the pulley integral (directly or not) with the cam (301) to which it hooks (cable grip). This causes rotation of said cam that acts according to the program (machined or cast, for example) on the derailing fork.

Preferably to avoid using overly long cables, the head of another cable (7B) is housed in the pulley of the cam (301). This cable (7B) under the action of rotation of the pulley of the cam (301) is subjected to pulling that is transmitted there also through the sheath(s) (6) and the sheath stops. This pulling movement is transmitted to a cable grip (40) housed in the pulley that is integral (directly or not) with the cam (601) of the rear derailleur (Z2). This action of the cable (7B) causes rotation of the pulley and thus of the cam (601), in doing so the cam directly (or almost directly) causes programmed movements (by machining or by casting for example) of derailing that will be obtained by a roller (33).

At the same time, another cable (5B) integral with the same cable grip (40) (or another) unwinds from the pulley of the cam (601) to wind onto the grip (X) through sheath(s) (6) and stop(s) of the sheath(s).

A counter-rotational action on the grip (X) will cause the reverse kinematics.

In the embodiment of the system (1) according to FIG. 1C, the grip (X) is integral with the first cable (4C) that, passing into at least one sheath (6), will transfer its pulling motion to the front derailleur according to the invention (Y3) and especially characterized by the fact that the cam (401) (that is the program of the front derailleur) is integral directly or not with the cam (402) (which is the program guiding the rear gear shifting system (Z3), in this case, a rather traditional rear derailleur). The cam(s) (401) and/or (402) can be single action or double action. As in the other versions and in general, a pulley receives the pulling motion of the cable (4C) and possibly of the cable (5C) to transform it into rotational motion driving the cam (401) and consequently in this case the cam (402) (or vice versa).

To control the rear derailleur (Z3), the cam (402) acts via a pin (403) that follows in contact and as freely as possible the profile of said cam (402); this pin (403) is integral with a connecting rod (404) that pivots around an axis (405) integral with one arm (20A) of the derailleur (Y3).

On this connecting rod (404), there is a housing near the free end to receive the head (7D) of the cable (7C).

By actuating this connecting rod (404), the cam (402) transmits its program (synchronized with the front derailleur (Y3) since said cam (402) is integral with the cam (401)) to the rear derailleur (Z3) via the cable (7C).

FIGS. 2A, 2B, 2C, and 2D show the front derailleur (Y1) in more detail. As indicated above, this version uses a single-action cam (201). In this case, it is desirable according to the invention that a return spring (203) (helical, for example) is housed in the cam (201) that advantageously acts in this case as a receiving pulley of the cable (4A). A cable grip (23) makes the cable (4A) integral with the cam/pulley (201).

In a particularly advantageous manner, the invention calls for this front derailleur (Y1) to be able to benefit from geometrical adjustment in three directions:

adjustment in height so as to satisfy the largest number of the largest chainrings, “C” in this case; for this, for example, the front derailleur (Y1) will be implemented with at least one first fixed part (8) integral with the frame (2) and/or the crankset box (W) and/or its crankset tube (3). At least one second movable part, the arms (16) and (20) (separate or one-piece) slide on the fixed part (8).

This movable part supports what is critical of the derailing elements of said derailleur.

To fix the movable part (16 and 20) on the fixed part (8), a screw (17) stops the sliding at the desired adjustment height by tightening the arms (16) and (20) against the fixed part (8).

To facilitate height adjustment of the movable part (16, 20), after loosening the screw (17), it is enough to turn the eccentric gear (19) by its hexagonal concave central part, so that said eccentric gear (19) turning centered as it is supported in the fixed part (8) will preferably push on the screw (17), driving the arms (16 and 20) up by the screw. Once the height adjustment (free space recommended between the bottom of the fork (9) and the tip of the tooth of the chainring “C” (for example the most highly eccentric) is implemented, it is simply enough to tighten the screw (17) to lock the desired adjustment. With a smaller degree of potentiality of adjustment, the eccentric gear (19) will be able to act on the rising but also on the lowering of the mobile part (16, 20).

adjustment in length, by the tilt that the fixed part (8) and thus the entire derailleur (Y1) could take. Effectively by turning around the axis of the crankset (W), the fixed part in height (8) (without modifying this said height) makes it possible to longitudinally adjust the lateral pressure point applied by the fork (9) to the chain. To do this, the fixed part (8) is arranged on its lower end in a collar (half-split or detachable) that surrounds by a groove (or a projection, a shoulder . . . ) the crankset box (W) (and/or its tube (3)), preferably on a flange (64) made on the screw/bearing (63). This flange (64) could be replaced by a washer (R) tightened between the screw/bearing (63) and the tube (3) of the crankset, and that would have a diameter greater than the screw/bearing (63) and the tube (3) to allow hooking and rotation of the collar (8).

To refine the adjustment and to maintain it, a screw (24) housed in the arm (20), for example, would be supported on the tube of the frame (2).

To lock the adjustment, at least one tightening (or connecting) screw (18) stops the collar (8) on the crankset box (W).

adjustment in width by the possibility that the male relief of the crankset box or the female relief of the adjustable part (the groove . . . of the collar (8)) mentioned above is wider than the female or male relief of the fixed part (flange (64) . . . ). This lateral play thus allows optional wedging to obtain the desired offset. Another approach consists in that the washer (R) (not shown) has an S section (a profile), which allows two potential adjustments by simply turning. In suggesting several types of washers (R) with different profiles, the adjustment possibilities are equally multiplied.

If the front derailleur is equipped with a single-action cam (201), the return spring (202) of the fork (9) is critical. In this case, according to the invention, said spring (202) will be able to be more or less taut (calibrated, pretensioned) at will. Actually, this spring (202), anchored on one end to a bell crank (21), is wound and can turn around one coaxial axis of said spring (202). On this axis, the other end of the spring (202) is anchored on a notched stop (14) and kept in position by a screw head (15) that works with said notches. The bell crank (21) pivotally bears the fork (9) via axles/rivets (13).

One axis (22) integral with the arm (20) ensures rotation of the cam/pulley (201). Split on its end next to the spring (203), said axis will be used as a fixed stop for the spring (203). The other end of the spring (203) will be used to bring back the cam/pulley (201) by anchoring it there.

The end of the fork (9) will be used to support a bearing in which the pin (12) that works with the cam (201) turns freely.

While the front derailleurs are equipped with a single-action or double-action cam, the stop screws (10) and (11) of the fork (9) are optional.

FIGS. 2E, 2F, and 2G show the cam (201) in detail. The positioning zones of the chainrings, in this case (201A) for chainring “A,” (201B) for chainring “B,” and (201C) for chainring “C.”

The cam (201) turns on a bearing (plain or roller) with a housing (222) that can have a shoulder and a clip groove for holding said bearing.

At least one cable grip (23) is housed in at least one recess (223).

The housing (203A) that accommodates the spring (203) can be sealed by a cover (not shown).

FIG. 3A shows in detail the derailleur (Y2) that is identical to the derailleur (Y1) except that the cam (301) is double action (desmodromic).

Preferably, this type of derailleur (Y2) works without any return spring; this results in that the cam/pulley (301) is actuated by a cable (4B) that makes it turn in one direction and another cable (7B) that makes the cam/pulley (301) turn in the other direction. Preferably, a single cable grip (23) makes the cables (4B) and (7B) integral (that can be but one and the same cable).

FIGS. 3B, 3C, and 3D show in detail the cam (301), the positioning zones of the chainrings, in this case the internal path (301A) and the external path (301A′) for the chainring “A,” (301B) and (301B′) for the chainring “B,” and (301C) and (301C′) for the chainring “C.”

The cam (301) turns on a bearing (plain or roller) with a housing (322) that can have a shoulder and a clip groove for holding said bearing.

At least one cable grip (23) is housed in at least one recess (323).

The pulley (304) of the cam is clearly visible here (FIG. 3D).

FIGS. 4A, 4B, 4C, 4D, 4E, and 4F show in detail the derailleur (Y3) that is relatively identical to the derailleur (Y1) due to the fact that the cam (401) is double action (desmodromic like the cam (301)).

Preferably, this type of derailleur (Y3) works without any return spring; this results in that the cam/pulley (401) is actuated by a cable (4C) that causes it to turn in one direction and another cable (5C) that causes the cam/pulley (401) to turn in the other direction. Preferably, a single cable grip (23) makes the cables (4C) and (5C) integral (this can only be one and the same cable).

The other main difference consists in that the cam (402) that guides the rear derailleur is an integral part of said front derailleur (Y3) and is directly or indirectly integral with the cam/pulley (401). As indicated above, the rear cam (402) actuates a pin (403) that is integral (but preferably free to rotate) with a connecting rod (404) that pivots around an axis (405) and that bears on its other end the head (7D) of the cable (7C). This axis (405) is fixed on the arm (20A) that is similar to the arm (20) if it is only here that the arm extends in a curve toward the top to comprise a plate on which the stops of the cables (4C), (5C) and (7C) are screwed (preferably to comprise possibilities for tensioning and adjusting the cables).

Preferably, the cam (402) will have gear click notches (28) that work with the pin (403).

FIGS. 4G and 4H respectively show in detail the cam (402) in front of the cam (401) and vice versa, with the outline of the rear cam (402) tinted. The positioning zones of the chainrings and cogs are indicated directly here in these figures. The cam (401) and also the cam (402) (possibly) turn on a bearing (plain or rolling) of which the housing (422) can have a shoulder and a clip groove for holding said bearing.

At least one cable grip (23) is housed in at least one recess (423). Advantageously, the cable grip (23) will rotationally link the cams (401) and (402).

The drive pulley of the two cams is preferably located between these two cams (401) and (402).

FIGS. 5A and 5B show in detail the rear derailleur (Z1).

As indicated above, this embodiment uses a single-action cam (501). In this case, it is desirable according to the invention that one return spring (42) (helical, for example) is housed in the cam (501) that advantageously acts in this case as the receiving pulley of the cable (5A). A cable grip (40) makes the cable (5A) integral with the cam/pulley (501).

A pin (38) that is preferably free to rotate follows in contact the track of the cam (501); this pin is integral with the pivoting arm (35) that traditionally forms with the other pivoting arm (36) the deformable parallelogram of said derailleur (Z1). The movement applied by the cam (501) to the arm (35) is thus transmitted by the arm (36) to a derailing roller (wheel) (33).

The support arm (31) of the chain tension system (32) is integral with the movable ends of the arms (35) and (36). The other fixed ends of the arms (35) and (36) are integral with a support element (37) that makes it possible to fasten the derailleur (Z1) to the bicycle frame using a screw (41).

In this embodiment, a spring (34) traditionally ensures the return of a roller (33) and components that are attached thereto (arm (31), chain adjuster (32)).

A plate (30) integral with the element (37) allows stopping of the sheath (6) of the cable (5A).

FIGS. 5C, 5D, and 5E show the cam (501) in detail. The positioning zones of the cogs, in this case FIG. 5C, the bosses of the cam (501), are indicated for example by: V1=A1; this indicates that the gear 1 (V1) is produced by the combination of the small chainring (A) and the large cog (1); V11=C6, which indicates that the gear 11 (V11) is produced by the combination of the large chainring (C) and the cog (6) . . . .

The cam (501) turns on a bearing (plain or rolling) with a housing (539) that can have a shoulder and a clip groove for holding said bearing.

At least one cable grip (40) is housed in at least one recess (540).

The housing (542) that accommodates the spring (42) can be sealed by a cover (not shown).

Relief recesses (511) can be implemented.

FIGS. 6A and 6B show in detail the derailleur (Z2) that is identical to the derailleur (Z1) except that the cam (601) is double action (desmodromic). Preferably, this type of derailleur (Z2) works without any return spring, which results in that the cam/pulley (601) is actuated by a cable (5B) that makes it turn in one direction and another cable (7B) that makes the cam/pulley (601) turn in the other direction. Preferably, a single cable grip (40) makes the cables (54B) and (7B) integral (which can be but one and the same cable).

FIGS. 6C, 6D and 6E show the cam (601) in detail, the positioning zones of the cogs, in this case the internal path (601A) and the external path (601B) with examples of similar bosses (for 601A) to the cam (501).

The cam (601) turns on a bearing (plain or rolling), of which the housing (639) can have a shoulder and a clip groove for holding said bearing.

At least one cable grip (40) is housed in at least one recess (640).

The pulley (605) of the cam is quite apparent here (FIG. 6E).

A hole (610) allows passage of an “Allen” wrench to tighten the screw (41).

Relief recesses (611) can be implemented.

FIGS. 7A, 7B, and 7C show in detail a twistgrip (X) without its protective casing for attachment to the handlebars.

In traversing at least one sheath (6), a positive pulling cable (4A or 4B or 4C) is wound and is anchored by its head (4A′) in a groove of the grip (X).

In traversing at least one sheath (6), a negative pulling cable (5A or 5B or 5C) is wound and is anchored by its head (5C′) in a groove of the grip (X).

A grooved part (50) will accommodate a lining of flexible material.

Marks (51) will display the engaged gear relative to a fixed reference of the housing of the grip (X).

Click notches (52) work with a click spring (53) to feel and position the grip (X) on the desired gear (51).

FIG. 8 shows in detail the housing of the crankset (W): an axis (50) that bears the pedal cranks turns on two bearings. A crossbar (62) wedges said bearings.

The left bearing is integral with a threaded sleeve or bearing/screw (61), and the right bearing is integral with a threaded sleeve or bearing/screw (63); these threaded sleeves (61) and (63) are screwed on the tube (3) of the crankset. The threaded sleeve (63) has a relief (64) allowing hooking and rotation of the front derailleur.

The various figures attached to the description do not comprise exhaustive suggestions of embodiments.

The system according to the invention is especially designed to shift the reduction ratios (gears) of a bicycle.

1. Bicycle equipped with a reduction ratio (gear) shifting system (1), of which at least one reduction ratio (gear) shifting means is a reduction ratio (gear) shifting means according to the invention, such as, for example, a front derailleur connected to its (own or common) transmitter control means and/or a rear derailleur connected to its (own or common) transmitter control means, characterized in that at least one traditional transmitter control means (click or not) and/or a transmitter control means according to the invention act(s) via at least one traditional transmission means (connecting means) and/or according to the invention on at least one gear shifting means (receiver control means) according to the invention that is controlled by at least one program (synchronized or unsynchronized between them if there are several) according to the invention, said program(s) being integrated at least into one of said gear shifting means (receiver control means) according to the invention, being one of the components comprising said gear shifting means.

2. Gear shifting system (1) according to claim 1, wherein the program(s) that control(s) the gear shifting means is (are) a cam (cams) with multiboss profiles, each of the fixed or modifiable bosses (raising of the fixed cam by design or parameterizable by controlled deformation of the cam path) of each cam corresponds to a reduction ratio (gear) selected for the intended gear shifting means. Each boss will be able to have or not have an “overshifting” zone in front of and/or following the desired positioning zone of the chain line.

3. Gear shifting system (1) according to claim 1, wherein the cam (201) controlling the front derailleur (Y1) is single action (pulling action) and integrates preferably (directly or by a bidirectional drive system) the receiving pulley (204) of the cable (4A). Said cable (4A) is integral with the pulley (204) by a cable grip (23). Always preferably a return spring (203) integrated into the pulley (204) will return said pulley (204) in the direction that is the reverse of the action of the cable (4A).

4. Gear shifting system (1) according to claim 1, wherein the cam (301) controlling the front derailleur (Y2) is double action (desmodromic, push-pull action) and integrates preferably (directly or by a bidirectional drive system) the receiving pulley (304) of the cable(s) (4B and 7B). Said cable(s) (4B and 7B) are integral with the pulley (304) by at least one cable grip (23). Always preferably neither a return spring (203) of said pulley (304) nor a derailing fork (9) is necessary.

5. Gear shifting system (1) according to claim 1, wherein the cam (401) controlling the front derailleur (Y3) is preferably double action (desmodromic, push-pull action) and integrates preferably (directly or by a bidirectional drive system) the receiving pulley of the cable(s) (4C and 5C). Said cable(s) (4C and 5C) is (are) integral with the pulley by at least one cable grip (23). Always preferably, neither a return spring of said pulley (304) nor a derailing fork (9) is necessary.
Another characteristic: the cam (402) controlling the rear derailleur (Z3) is integral (monoblock or assembled) with the cam (401). This interdependence offers direct synchronization of the front and rear gear shifting means (chainrings (A/B/ . . . ) and cogs (1/2/ . . . ) that allows optional combination of potential reduction ratios.
Preferably, this cam (402) will have gear click notches that will work with a pin (403). This pin (403) also actuates a connecting rod (404) on the free end of which the head (7D) of a cable (7C) acts on a rather traditional rear gear shifting means (a rear derailleur (Z3) for example).

6. Gear shifting system (1) according to claim 1, wherein the cam (501) controlling the rear derailleur (Z1) is single action (pulling action) and integrates preferably (directly or by a bidirectional drive system) the receiving pulley (505) of the cable (5A). Said cable (5A) is integral with the pulley (501) by a cable grip (40). Always preferably a return spring (42) integrated into the pulley (505) will return said pulley (505) in the direction that is the reverse of the action of the cable (5A).

7. Gear shifting system (1) according to claim 1, wherein the cam (601) controlling the rear derailleur (Z2) is preferably double action (desmodromic, push-pull action) and integrates preferably (directly or by a bidirectional drive system) the receiving pulley (605) of the cable(s) (5B and 7B). Said cable(s) (5B and 7B) are integral with the pulley (605) by at least one cable grip (40). Always preferably, neither a return spring of said pulley (605) nor a derailing roller (33) is necessary.

8. Gear shifting system (1) according to claim 1, wherein the means of transmission (connection) and possible synchronization between the transmitter control mean(s) (MCE) and the reduction ratio shifting means (front=MRF and rear=MRR) can be:

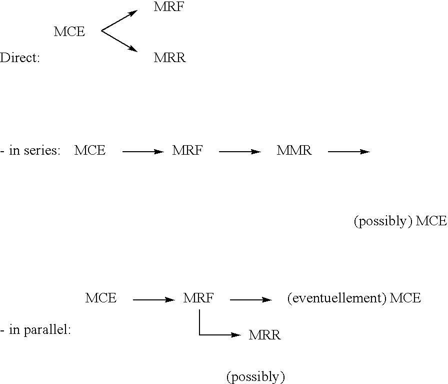

9. Gear shifting system (1) according to claim 1, wherein the transmitter control means can be: manual, clicked or not, assisted or not and/or vocal. Said transmitter control means will be able to act permanently or interchangeably with continuous movement on all or some of the program(s) or in a sequential mode by shifting at least one gear for each pulse with automatic (preferably) return to neutral.

10. Gear shifting system (1) according to claim 1, wherein the transmission (connection) means can be: mechanical and/or hydraulic and/or pneumatic and/or Hertzian.

11. Gear shifting system (1) according to claim 1, wherein the program(s) is (are) controlled and can be actuated by any (all) exclusive or hybrid device(s) and/or system(s).

12. Gear shifting system (1) according to claim 1, wherein one or more elements of the invention can be more or less waterproof, more or less protected together or separately.

13. Gear shifting system (1) according to claim 1, wherein the rear derailleur and/or the front derailleur can have more than one chain-tensioning caster.

14. Gear shifting system (1) according to claim 1, wherein the front derailleur can be adjusted in three directions, especially, for example, in height by sliding the movable arms (18 and 20) on a fixed part (8) (in height relative to the largest chainring); an eccentric gear (19) turning in the fixed part (8) will act on the tightening screw (17); this eccentric gear (19) ensures precise positioning of the movable bearing part of the fork (9) with respect to the fixed part (8).

15. Gear shifting system (1) according to claim 14, wherein a relief (64) of the casing of the crankset (W) and/or of the tube of the crankset (3) and/or of a more or less S-shaped washer works with ad hoc relief of the front derailleur that allows adjustments in width and length (by rotation and thus tilting) of said front derailleur.
